(19) United States
(12) Patent Application Publication
(10) Pub. No.: US 2025/0128691 A1
(43) Pub. Date: Apr. 24, 2025

(54) STEER-BY-WIRE-SYSTEM AND METHOD FOR SAME

(71) Applicant: ZF AUTOMOTIVE GERMANY GMBH, Alfdorf (DE)

(72) Inventor: Peter HAMBLOCH, Krefeld (DE)

(21) Appl. No.: 18/920,122

(22) Filed: Oct. 18, 2024

(30) Foreign Application Priority Data
Oct. 20, 2023 (DE) 10 2023 210 367.2

(51) Int. Cl. B60W 10/20

(52) U.S. Cl. CPC B60W 10/20; B60W 2540/18; B60W 2720/14

(57) ABSTRACT

A steer-by-wire steering system (10) for a vehicle is specified, having a control element (12) that can be actuated by a driver for inputting a steering angle, an actuating mechanism (14) for setting a wheel setting angle, and a control unit (28) that is configured to output a characteristic map for the target value of a position of the actuating mechanism (14) based on a steering angle of the control element (12) and a vehicle speed. A nominal wheel setting angle (y) adjustable by the actuating mechanism (14) depends on a set steering angle and on a vehicle speed, wherein the maximum settable nominal wheel setting angle (y_{m,n}) is limited depending on the vehicle speed, and wherein the control unit (28) is configured to calculate a vehicle trajectory based on a vehicle speed and a wheel setting angle and, in the event of a deviation of an actual vehicle trajectory from the calculated vehicle trajectory, to adjust the maximum settable nominal wheel setting angle (y_{m,n}) based on the deviation. Furthermore, a method for method for adjusting a wheel setting angle is specified.

### TECHNICAL FIELD

The invention relates to a steer-by-wire steering system for a vehicle and a method for creating a characteristic map for the target value of a position of the actuating mechanism for setting a wheel setting angle in a steer-by-wire steering system.

### BACKGROUND

Steering systems typically comprise a rack that is mounted for linear movement to adjust a wheel position. Originally, such a rack is coupled to the steering wheel via a steering rod, such that a linear displacement of the rack is achieved by turning the steering wheel.

In modern motor vehicles, so-called steer-by-wire steering systems (SbW steering system), in which there is no longer any mechanical connection between the steering wheel and the rack, are increasingly being used. The movement of the rack is achieved by means of an electric drive, in particular by means of a servomotor.

For steer-by-wire steering systems, theoretically any ratio of a steering angle to a wheel setting angle can be set. In this context, one also speaks of a virtual gear ratio.

The course of the virtual gear ratio is determined by a function which is based, among other things, on the maximum travel of the servo motor on the front axle and the steering angle.

It is known to limit the maximum wheel setting angle depending on the vehicle speed, wherein the physical travel of the rack or the travel of the electric drive on the front axle is limited.

In non-linear driving situations, it may happen that the maximum wheel setting angle is not optimal with respect to the driving behavior of the vehicle.

### SUMMARY

It is therefore an object of the present invention to provide an improved steering system and a method for adjusting a maximum settable wheel setting angle and consequently the course of the virtual gear ratio up to that point in a steer-by-wire steering system.

This object is achieved, according to the invention, by a steer-by-wire steering system for a vehicle, having a control element that can be actuated by a driver for inputting a steering angle, an actuating mechanism for setting a wheel setting angle, and a control unit that is configured to output a characteristic map for the target value of a position of the actuating mechanism based on a steering angle of the control element and a vehicle speed, wherein a nominal wheel setting angle that can be set by the actuating mechanism depends on a set steering angle and on a vehicle speed, wherein the maximum settable nominal wheel setting angle is limited depending on the vehicle speed, and wherein the control unit is configured to calculate a vehicle trajectory based on a vehicle speed and a wheel setting angle and, if an actual vehicle trajectory deviates from the calculated vehicle trajectory, to adjust the maximum settable nominal wheel setting angle based on the deviation.

The wheel setting angle on which the vehicle trajectory is calculated can be a set or a virtually requested wheel setting angle.

In particular, the control unit is configured to adjust the maximum settable nominal wheel setting angle based on the deviation and the signs of the current wheel setting angle and the vehicle trajectory if an actual vehicle trajectory deviates from the calculated vehicle trajectory.

Based on the characteristic map, which is formed by a function taking into account the maximum settable nominal wheel setting angle, a ratio between a deflection of the control element and a wheel setting angle set by the actuating mechanism is defined for different driving situations.

The ratio determined by the map is a virtual ratio because there is no mechanical connection between the control element and the wheels. The virtual ratio thus replaces the mechanical gear ratio that is no longer present in the steer-by-wire steering system and is therefore also referred to as a virtual gear ratio. In addition, the wheel setting angle can be determined directly from the steering angle in the steer-by-wire steering system, whereas the actual wheel setting angle for a steering angle must be determined taking into account the gear ratio change up to this position in a conventional EPS steering system with a mechanical gearbox.

Between a steering angle of a defined middle range corresponding to a neutral position of the control element and the maximum steering angle, the virtual gear ratio varies depending on the driving situation, making the vehicle intuitive and pleasant to steer for the driver.

The steering behavior can be optimized in the event of oversteering or understeering of the vehicle by means of the steering system according to the invention. Oversteering or understeering of the vehicle can be determined in particular by the deviation of the actual vehicle trajectory from the calculated vehicle trajectory. The deviation of the actual and calculated vehicle trajectories is also called the side slip angle.

By adjusting the maximum settable nominal wheel setting angle based on the deviation and the signs of the current wheel setting angle and vehicle trajectory, the actual vehicle trajectory can be brought closer to the calculated vehicle trajectory. In other words, the adjustment stabilizes the driving situation when understeering or oversteering occurs during steady-state cornering. In addition, a larger wheel setting angle range is available to the driver when oversteering for countersteering. In this way, the driver's countersteering is supported if the vehicle oversteers or understeers. This leads to increased driving comfort, increased driving safety, and improved steering behavior of the vehicle. This is deliberately not a classic position overlay or position control for driving stabilization, for example by a factor applied to a target wheel setting angle or a blending. Such an approach would correspond to a control of the wheel setting angle to explicitly reduce or suppress side slip angles, wherein, in the sense of the present application, oversteering or understeering is permitted, but should be easily controllable. The driver should, as far as possible, maintain anticipation of the wheel position based on the position of the control element (psychological advantage) to make manual steering (handling) intuitive—for example, the wheel position always corresponds to driving straight ahead when the control element is in the neutral position.

In the event of understeering or when the actual vehicle trajectory and the wheel setting angle are aligned in the event of oversteering, the maximum wheel setting angle is in particular reduced, thereby achieving a more indirect ratio between the steering angle and the wheel setting angle.

In the event of oversteering, when the actual vehicle trajectory does not correspond to the wheel setting angle, the maximum wheel setting angle is in particular increased such that a more direct ratio between the steering angle and the wheel setting angle is achieved.

In this way, the virtual gear ratio can be adjusted to benefit the driver in every driving situation.

The nominal wheel setting angle corresponds to the wheel setting angle at which the calculated vehicle trajectory matches the actual vehicle trajectory. The nominal wheel setting angle serves in particular as an initial value for adjusting the wheel setting angle in response to a deviation of the actual vehicle trajectory from the calculated vehicle trajectory. A tolerance range for small deviations is conceivable, in particular to compensate for inaccuracies in the calculation of the driving situation, for example due to measurement noise.

In particular, the maximum nominal wheel setting angle is lower than the physically possible wheel setting angle, so that the maximum settable nominal wheel setting angle can be adjusted upwards and downwards.

The maximum settable nominal wheel setting angle is preferably a defined wheel setting angle that can be set depending on the vehicle speed. At higher vehicle speeds, the maximum settable nominal wheel setting angle is preferably smaller than at lower vehicle speeds.

In the parking and rolling areas, no adjustment is usually necessary, because the physically maximum wheel setting angle is desired to achieve an optimal turning circle.

The control element can be a conventional steering wheel, a control stick, a flat, flattened, or square steering wheel, a rotary potentiometer, or a joystick, for example.

A maximum possible steering angle is, for example, +/−180°. This makes the steering system particularly suitable for so-called flat control elements such as a control stick or flat, square steering wheels, where reaching over the steering wheel is not intended, but the driver's hands grip the control element in a recommended position during a trip, in particular the so-called “quarter-to-three position.”

According to one embodiment, the steering system comprises a yaw rate sensor, and the control unit is configured to detect the measured yaw rate and calculate a yaw rate acting on the vehicle and to compare the calculated yaw rate with the yaw rate measured by the yaw rate sensor, wherein a deviation of the actual vehicle trajectory from the calculated vehicle trajectory can be determined based on a deviation of the calculated yaw rate from the measured yaw rate. The deviation of the calculated yaw rate from the measured yaw rate is particularly analogous to a deviation of the actual vehicle trajectory from the calculated vehicle trajectory. Using a yaw rate sensor, a deviation of the actual vehicle trajectory from the calculated vehicle trajectory can be estimated with sufficient accuracy.

The yaw rate is calculated by the control unit based on a linear single-track model that includes the steering angle and the vehicle speed.

Alternatively or additionally, further information regarding vehicle orientation from data acquisition, condition estimation, or condition monitoring can be used.

Based on the deviation of the actual yaw rate from the calculated yaw rate, a deviation factor can be determined, in particular wherein the deviation factor for different deviations is stored in a lookup table. The deviation factor provides information about the degree of deviation of the actual from the calculated vehicle trajectory.

According to DIN ISO 8855:2013-11, the sign of the deviation factor can be used to determine whether the deviation was caused by oversteering or understeering of the vehicle. In a left turn, a negative sign indicates understeering behavior, a positive sign indicates oversteering behavior. In a right, turn the signs are reversed.

For example, the deviation factor takes values between −1 and 1, wherein a value of zero means that there is no deviation, i.e., that the actual vehicle trajectory corresponds to the calculated vehicle trajectory.

By storing the deviation factor for different deviations in a lookup table, the deviation factor can be determined particularly quickly and without complex calculations.

As an alternative to a lookup table, a course described by a function is conceivable.

A tolerance range can also be specified when determining the deviation to compensate for inaccuracies in the calculation of the driving situation, for example due to measurement noise.

In addition, the sign of the calculated yaw rate compared with that of the measured yaw rate indicates whether the driver is steering in the direction of the vehicle trajectory or against it.

Alternatively, it is conceivable that the deviation of the actual vehicle trajectory from the measured vehicle trajectory based on steering-internal variables can be determined by comparing a rack force calculated using a linear single-track model to a steering rack force determined using a steering model that includes steering-internal measured variables. Such a calculation is advantageous compared to a comparison of measured and calculated yaw rates in terms of processing time, since the processing of steering-internal variables on the bus system is faster than the processing of received measured variables. In this way, the performance of the steering system can be improved.

In an alternative embodiment, the steering angle and/or information for determining the driving situation, in particular a deviation of the vehicle trajectory or of the side slip angle, can be determined using a sensor or a control unit outside the steering system. Implementation is therefore basically also possible in cooperation with other control units in the vehicle. However, a comprehensive control for driving stabilization within the brake, wherein a target value for the wheel setting angle is to be received and set by the steering at most, is excluded within the meaning of the application.

The control unit is preferably configured to set an upper limit value and a lower limit value of the maximum settable wheel setting angle based on the vehicle speed, wherein the maximum settable nominal wheel setting angle lies between the upper limit value and the lower limit value. When adjusting the maximum wheel setting angle based on the deviation of the actual vehicle trajectory from the calculated vehicle trajectory and in particular the sign comparison of the actual vehicle trajectory and the wheel setting angle, the maximum wheel setting angle cannot be adjusted beyond the upper and lower limit values. This ensures that the adjustment is within a tested and applied range. In particular, the wheel setting angle is adjusted within a tested range that is comfortable for the driver, thereby increasing driving safety.

Based on the deviation factor, the control unit can set an adjusted maximum settable wheel setting angle that is between the upper limit value and the lower limit value of the wheel setting angle. The larger the value of the deviation factor, the closer the adjusted maximum settable wheel setting angle is to the upper or lower limit value. In this way, the control unit can determine the adjusted maximum settable wheel setting angle particularly easily based on the limit values and the deviation factor. During understeering and oversteering, when the signs of the vehicle trajectory and the wheel setting angle are the same, the adjustment converges towards the lower limit value. Accordingly, if oversteering with opposite signs, the adjustment converges towards the upper limit value vauel.

Both the upper limit value and the lower limit value of the maximum settable wheel setting angle depend in particular on the vehicle speed. The adjustment option for the wheel setting angle is therefore adjusted to the driving situation.

The difference between the upper limit value and the lower limit value preferably increases with increasing deflection of the control element. The scope that the control unit has for adjusting the wheel setting angle is thus adjusted to the steering movement performed by a driver. In other words, this avoids a strong correction of the wheel setting angle when the driver steers around the center position of the control element, while a stronger correction is possible for larger deflections. In this way, the wheel positioning dynamics and the wheel positioning travel are reduced or increased as required, and this becomes increasingly pronounced outside the neural area with increasing deflection of the control element.

At least two, in particular at least five, vehicle speed support points can be stored in the control unit, wherein the control unit is configured to calculate a course of the ratio between a deflection of the control element and the nominal wheel setting angle set by the actuating mechanism for the vehicle speed support points using the steering angle. By storing vehicle speed support points for which the course of the virtual gear ratio is calculated, the gear ratio is calculated exactly for a limited number of vehicle speeds only. This can significantly reduce the required computing capacity of the control unit.

Preferably, the control unit is configured to interpolate a target value for the actuating mechanism between the vehicle speed support points. In this way, a characteristic map for the respective vehicle speed can be defined with sufficient accuracy even with reduced computing capacity.

The actuating mechanism can comprise a rack or at least an electromotive actuator. Both a rack and an electromotive actuator are suitable for setting a defined wheel setting angle.

For example, a separate electromotive actuator can be provided for each wheel of a vehicle.

The object is further achieved, according to the invention, by a method for adjusting a maximum settable wheel setting angle, in particular a course of the virtual gear ratio, in a steer-by-wire steering system for a vehicle. In one method step, a characteristic map for the target value of a position of the actuating mechanism is output based on a steering angle of the control element and a vehicle speed, wherein a nominal wheel setting angle settable by the actuating mechanism depends on a set steering angle and on a vehicle speed. A maximum settable nominal wheel setting angle is limited depending on the vehicle speed and is particularly used for the design of the characteristic map. In another method step, a vehicle trajectory is calculated based on a vehicle speed and a wheel setting angle, in particular a set wheel setting angle or a virtually requested wheel setting angle. Furthermore, the maximum settable nominal wheel setting angle is adjusted based on the deviation of an actual vehicle trajectory from the calculated vehicle trajectory.

As already explained in connection with the steering system, the method according to the invention has the advantage that the steering behavior can be optimized in the event of oversteering or understeering of the vehicle and thus support the driver.

In addition, the maximum settable nominal wheel setting angle can be adjusted based on the signs of the current wheel setting angle and vehicle trajectory.

The adaptation improves the maneuverability of the vehicle by correcting the wheel position, which tends to have a stabilizing effect. In particular, the wheel setting range is enlarged or reduced.

Only a very limited deviation is possible in comparison to a comprehensive driving stability control system in the sense of a lateral dynamics control via the target wheel setting angle. In comparison, the impact of a faulty input signal is manageable. Furthermore, adjustment is zero in a defined neutral area of the control element, which eliminates the need for blending or rate-limit valueing measures when steering through the center.

In another method step, for example, a yaw rate acting on the vehicle is calculated, and the calculated yaw rate is compared with a yaw rate measured by a yaw rate sensor. Then in particular deviation of the actual vehicle trajectory from the calculated vehicle trajectory is determined based on a deviation of the calculated yaw rate from the measured yaw rate. As already explained in connection with the steering system, this can be used to detect oversteering or understeering.

Based on the deviation of the actual yaw rate from the calculated yaw rate, a deviation factor can be determined, in particular wherein the deviation factor for different deviations is stored in a lookup table. The deviation factor provides information about the degree of deviation of the actual from the calculated vehicle trajectory.

According to one embodiment, an upper limit value and a lower limit value of the maximum settable wheel setting angle can be specified based on the vehicle speed, wherein the maximum settable nominal wheel setting angle lies between the upper limit value and the lower limit value. By specifying the upper and lower limit values, it is ensured that the adjusted wheel setting angle is within a defined range.

Based on the deviation factor, a maximum wheel setting angle can be specified that lies between the upper limit value and the lower limit value of the wheel setting angle. In this way, the adjusted wheel setting angle can be calculated particularly easily.

For example, when understeering and, if in oversteering the measured and calculated yaw rates have the same signs, the adjustment is made towards the lower limit value, and in oversteering with opposite signs, the adjustment is made towards the upper limit value. In this way, the steering behavior can be optimized particularly well in the event of oversteering or understeering of the vehicle.

Whether oversteering or understeering is present is determined primarily by the difference between the calculated and measured yaw rates. If the difference is less than zero, there is understeering. If the difference is greater than zero, there is oversteering.

### BRIEF DESCRIPTION OF THE DRAWINGS

Further advantages and features of the invention will be apparent from the following description and the accompanying drawings which are referenced. In particular:

FIG. 1 shows schematically a steer-by-wire steering system according to the invention,

FIG. 2 shows the course of a wheel setting angle for a defined vehicle speed,

FIG. 3 shows a block diagram illustrating a method according to the invention for adjusting a maximum settable wheel setting angle, and

FIG. 4 shows the course of a virtual overall gear ratio for a defined vehicle speed.

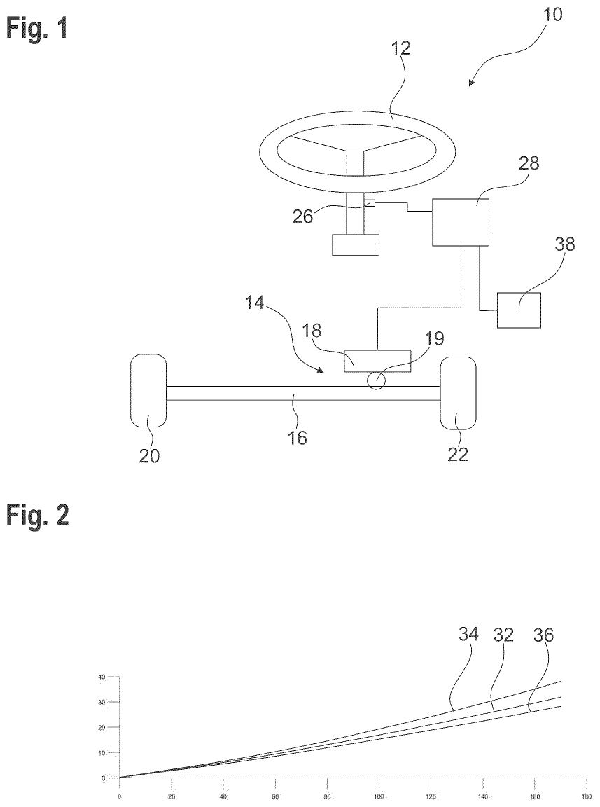

FIG. 1 schematically illustrates a steer-by-wire steering system 10 for a vehicle with a control element 12, which in the embodiment is a steering wheel.

### DESCRIPTION

The steering system 10 further comprises an adjusting mechanism 14.

In the illustrated embodiment, the actuating mechanism 14 comprises a rack 16 and an actuator 18, wherein a mechanical transmission mechanism acts between the rack 16 and the actuator 18, which is implemented by a pinion 19 in the embodiment. Alternatively, a recirculating ball bearing or the like is also conceivable.

The rack 16 forms a front axle which carries two front wheels 20, 22. However, the system can also be applied to rear-axle steering.

In an alternative embodiment, which is not shown for the sake of simplicity, the adjusting mechanism 14 comprises electromotive actuators instead of a rack 16 and a pinion 19, wherein each wheel 20, 22 is associated with an actuator.

In a steer-by-wire steering system 10, there is no mechanical coupling between the control element 12 and wheels 20, 22. Instead, a wheel setting angle is set by means of the servo motor 18.

For this purpose, the pinion 19, which is in toothed engagement with the rack 16, is rotated by means of the servo motor 18, whereby the rack 16 is moved linearly.

For the rack 16, for example, a maximum travel of +/−90 mm is defined, starting from a neutral position.

The steering system 10 has a sensor 26, for example an angle sensor, which serves to detect a steering angle.

Based on the steering angle detected by the sensor 26, a signal is sent to a servo motor 18.

More specifically, the steering system 10 has a control unit 28 which processes a value detected by the sensor 26 and sends a corresponding signal to the actuator 18.

The control unit 28 is in particular configured to output a characteristic map for the target value of a position of the actuating mechanism 14 based on a steering angle of the control element 12 and a vehicle speed. Specifically, a target position or a state of the servo motor 18 is specified. Thus, the wheel setting angle settable by the adjusting mechanism 14 depends on 25 a set steering angle and on a vehicle speed.

A maximum settable nominal wheel setting angle ym,n is limited depending on the vehicle speed.

With regard to the calculation of the characteristic map based on the maximum settable nominal wheel setting angle ym,n in detail, reference is made in full to the content of DE 10 2022 213 299 A1. By means of the present invention, the maximum settable nominal wheel setting angle ym,n is adjusted to specific driving situations.

As described in DE 10 2022 213 299 A1, a course of the ratio between a deflection of the control element 12 and the nominal wheel setting angle y set by the actuating mechanism 14 can be determined, at least in some areas, as a function of the steering angle using a third-degree polynomial function.

The maximum settable steering angle can also be limited depending on the vehicle speed.

The wheel setting angle is also limited to an absolute maximum value. The absolute maximum wheel setting angle is reached when the rack 16 has covered its defined maximum travel. The absolute maximum wheel setting angle therefore corresponds to the maximum physically possible wheel setting angle.

FIG. 2 illustrates the course of a nominal wheel setting angle y based on a maximum settable nominal wheel setting angle ym,n as a function of a steering angle for a defined vehicle speed based on curve 32. The defined vehicle speed is, for example, 30 km/h.

Furthermore, it can be seen from FIG. 2 that the nominal wheel setting angle y can be adjusted according to the invention within defined limit values, in particular by changing the value of the maximum settable nominal wheel setting angle ym,n.

In particular, FIG. 2 shows the course based on a maximum adjustable upper limit value ym,o of the wheel setting angle using a curve 34 and the course based on a maximum settable lower limit value ym,u of the wheel setting angle using curve 36. The limit values depend in particular on the vehicle speed.

As can be seen in FIG. 2, the difference between the upper limit value and the lower limit value increases with increasing deflection of the control element.

An adjustment of the maximum settable nominal wheel setting angle ym,n to a value within the upper limit value ym,o and the lower limit value ym,u is carried out, for example, when an actual vehicle trajectory deviates from a desired vehicle trajectory, in particular when oversteering or understeering of the vehicle occurs.

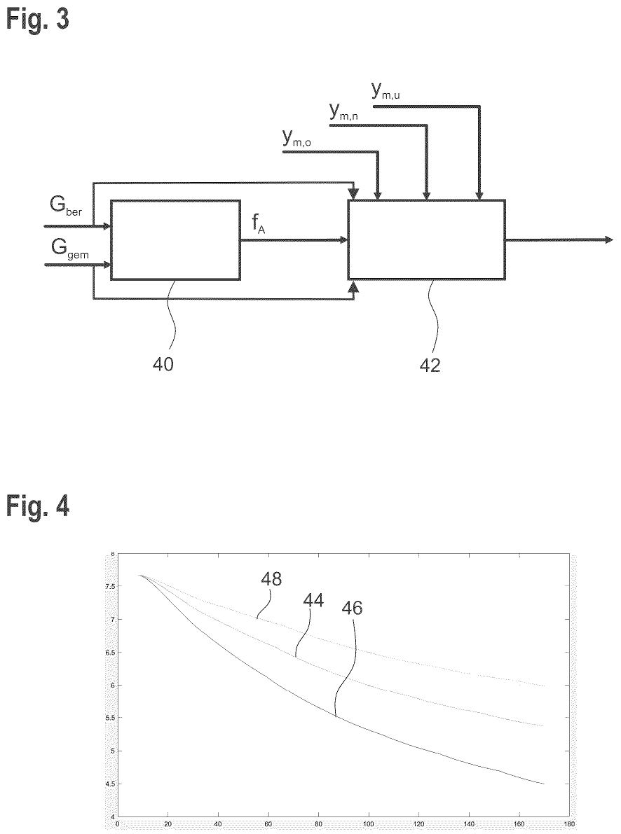

The method for adjusting the maximum settable nominal wheel setting angle ym,n is explained with reference to FIG. 2 and FIG. 3, which shows a block diagram to illustrate a method according to the invention.

First, the control unit 28 determines whether a corresponding deviation exists in that the control unit (28) calculates a vehicle trajectory based on a vehicle speed and a set wheel setting angle and compares it to an actual vehicle trajectory.

This is done, for example, by means of a yaw rate sensor 38, which is shown schematically in FIG. 1.

In particular, a yaw rate acting on the vehicle is calculated and the calculated yaw rate Gber is compared with the yaw rate Ggem measured by the yaw rate sensor 38. This process step is illustrated in FIG. 3 by block 40. For example, the yaw rate acting on the vehicle is calculated based on a simple, linear single-track model.

The calculation of the yaw rate Gber and the comparison of the calculated yaw rate Gber to the measured yaw rate Ggem is carried out by the control unit 28.

Then a deviation of the actual vehicle trajectory from the calculated vehicle trajectory is determined based on a deviation of the calculated yaw rate Gber from the measured yaw rate Ggem.

If a deviation of the actual vehicle trajectory from the calculated vehicle trajectory is detected, the maximum settable wheel setting angle is adjusted based on the deviation, also by the control unit 28.

The adjustment is carried out taking into account a deviation factor fA, which is determined in particular in block 40 based on the deviation of the actually measured yaw rate Gber from the calculated yaw rate Gber.

For example, the deviation factor fA for different deviations is stored in a lookup table.

Based on the deviation factor fA, an adjusted value for the maximum settable wheel setting angle is determined, which lies between the upper limit value ym,o and the lower limit value ym,u of the wheel setting angle.

In particular, in block 42, the maximum settable nominal wheel setting angle ym,n is adjusted taking into account the upper limit value ym,o or the lower limit value ym,u and the compensation factor fA. The control unit 28 determines the adjusted maximum settable wheel setting angle such that it lies in a ratio corresponding to the compensation factor fA between the maximum settable nominal wheel setting angle ym,n and the upper limit value ym,o or the lower limit value ym,u. This means that, if the compensation factor is 0.5, the adjusted maximum settable wheel setting angle is exactly in the middle between the maximum settable nominal wheel setting angle ym,n and the upper limit value ym,o

The higher the compensation factor fA, the closer the resulting value for the maximum settable wheel setting angle is to one of the limit values.

In understeering, and if in oversteering the measured and the calculated yaw rates have the same sign, an adjustment is made towards the lower limit value ym,u. In oversteering and with opposite signs, the adjustment is made towards the upper limit value ym,o. To compare the signs of the measured and the calculated yaw rates, the values of the measured yaw rate and the calculated yaw rate are entered into block 42. Specifically, the difference Gber—Ggem is determined. If the difference is less than zero, there is understeering. If the difference is greater than zero, there is oversteering.

As an alternative to an adjustment of the maximum settable nominal wheel setting angle based on the upper limit value ym,o and the lower limit value ym,u, a scaling of the maximum settable nominal wheel setting angle by factors is also possible. This means that the upper and lower limit values can each be a relative value with reference to the maximum settable nominal wheel setting angle ym,n instead of an absolute value dependent on the wheel setting angle. For example, instead of the upper absolute limit value, an offset can be added to the maximum settable nominal wheel setting angle ym,n. Alternatively, the limit values can be increased or decreased in percent from the maximum settable nominal wheel setting angle ym,n, wherein 100% is the distance between the maximum settable nominal wheel setting angle ym,n and the physically possible wheel setting angle.

Adjustment of the maximum settable nominal wheel setting angle preferably only takes place above a defined vehicle speed, in particular above 20 km/h.

FIG. 4 shows a course of the overall gear ratio between the control element 12 and the wheel stall angle over the steering angle of the control element 12, both for the maximum settable nominal wheel setting angle ym,n using curve 44 and for the upper limit value ym,o using curve 46 and for the lower limit value ym,u using curve 48. In particular, the course of the gear ratio at a speed of 30 km/h is illustrated.

The overall gear ratio decreases with increasing steering angle, i.e., it becomes more direct with increasing steering angle.

At a steering angle between zero and 10°, the overall gear ratio is constant. This results in a particularly indirect virtual gear ratio around the center position of the control element 12, which leads to improved controllability of the vehicle.

In the exemplary embodiment, FIGS. 2 and 4 illustrate the course of the wheel setting angle and the overall gear ratio for a defined speed of 30 km/h.

However, at least two, in particular at least five, vehicle speed support points are stored in the control unit 28, wherein the control unit 28 is set up to calculate a course of the ratio between a deflection of the control element 12 and the wheel setting angle ym to be set by the actuating mechanism 14 via the steering angle for the vehicle speed support points based on the maximum settable wheel setting angle, which is determined in block 42.

The control unit 28 can interpolate the required values between the vehicle speed support points.

1. A steer-by-wire steering system (10) for a vehicle, having a control element (12) that can be actuated by a driver for inputting a steering angle, an actuating mechanism (14) for setting a wheel setting angle, and a control unit (28) that is configured to output a characteristic map for the target value of a position of the actuating mechanism (14) based on a steering angle of the control element (12) and a vehicle speed, wherein a nominal wheel setting angle (y) that can be set by the actuating mechanism (14) depends on a set steering angle and on a vehicle speed, wherein the maximum settable nominal wheel setting angle (y_{m,n}) is limited depending on the vehicle speed, and wherein the control unit (28) is configured to calculate a vehicle trajectory based on a vehicle speed and a wheel setting angle and, if an actual vehicle trajectory deviates from the calculated vehicle trajectory, to adjust the maximum settable nominal wheel setting angle (y_{m,n}) based on the deviation.

2. The steer-by-wire steering system (10) according to claim 1, wherein the steering system (10) comprises a yaw rate sensor (38) and the control unit (28) is configured to detect the measured yaw rate and calculate a yaw rate acting on the vehicle, and to compare the calculated yaw rate (G_{ber}) with the yaw rate (G_{gem}) measured by the yaw rate sensor, wherein a deviation of the actual vehicle trajectory from the calculated vehicle trajectory can be determined based on a deviation of the calculated yaw rate (G_{ber}) from the measured yaw rate G_{gem}.

3. The steer-by-wire steering system (10) according to claim 2, wherein a deviation factor (f_{A}) is determined based on the deviation of the actual yaw rate (G_{gem}) from the calculated yaw rate (G_{ber}), in particular wherein the deviation factor (f_{A}) for different deviations is stored in a lookup table.

4. The steer-by-wire steering system (10) according to claim 1, wherein the deviation of the actual vehicle trajectory from the measured vehicle trajectory based on steering-internal variables can be determined by comparing a rack force calculated using a linear single-track model with a rack force determined using a steering model that includes steering-internal measured variables.

5. The steer-by-wire steering system (10) according to claim 1, wherein the steering angle and/or information for determining the driving situation can be determined using a sensor or a control device outside the steering system.

6. The steer-by-wire steering system (10) according to claim 1, wherein the control unit (28) is configured to set an upper limit value (y_{m,o}) and a lower limit value (y_{m,u}) of the maximum settable wheel setting angle based on the vehicle speed, wherein the maximum settable nominal wheel setting angle (y_{m,n}) lies between the upper limit value and the lower limit value.

7. The steer-by-wire steering system (10) according to claim 3, wherein the control unit (28) determines an adjusted maximum settable wheel setting angle (y) based on the deviation factor (f_{A}), which angle lies between the upper limit value (y_{m,o}) and the lower limit value (y_{m,u}) of the wheel setting angle.

8. The steer-by-wire steering system (10) according to claim 6, wherein both the upper limit value (y_{m,o}) and the lower limit value (y_{m,u}) of the maximum settable wheel setting angle are dependent on the vehicle speed.

9. The steer-by-wire steering system (10) according to claim 6, wherein the difference between the upper limit value (y_{m,o}) and the lower limit value (y_{m,u}) increases with increasing deflection of the control element (12).

10. The steer-by-wire steering system (10) according to claim 1, wherein at least two, in particular at least five, vehicle speed support points are stored in the control unit (28), wherein the control unit (28) is configured to calculate a course of the ratio between a deflection of the control element (12) and the nominal wheel setting angle (y) set by the actuating mechanism via the steering angle for the vehicle speed support points.

11. The steer-by-wire steering system (10) according to claim 1, wherein the actuating mechanism (14) comprises a rack (16) or at least one electromotive actuator.

12. A method for adjusting a maximum settable wheel setting angle in a steer-by-wire steering system (10) for a vehicle according to claim 1, comprising the following steps:
outputting a characteristic map for the target value of a position of the actuating mechanism (14) based on a steering angle of the control element (12) and a vehicle speed, wherein a nominal wheel setting angle (y) adjustable by the actuating mechanism (12) depends on a set steering angle and on a vehicle speed, wherein the maximum adjustable nominal wheel setting angle (y_{m,n}) is limited depending on the vehicle speed,
calculating a vehicle trajectory based on a vehicle speed and a wheel setting angle, and
adjusting the maximum settable nominal wheel setting angle (y_{m,n}) based on the deviation of an actual vehicle trajectory from the calculated vehicle trajectory.

13. The method according to claim 12, wherein the following further steps are provided:
calculating a yaw rate acting on the vehicle and comparing the calculated yaw rate (G_{ber}) with a yaw rate measured by a yaw rate sensor (G_{gem}), and
determining a deviation of the actual vehicle trajectory from the calculated vehicle trajectory based on a deviation of the calculated yaw rate G_{ber} from the measured yaw rate G_{gem}.

14. The method according to claim 13, wherein a deviation factor (f_{A}) is determined based on the deviation of the actual yaw rate (G_{gem}) from the calculated yaw rate (G_{ber}), in particular wherein the deviation factor (f_{A}) for different deviations is stored in a lookup table.

15. The method according to claim 12, wherein an upper limit value (y_{m,o}) and a lower limit value (y_{m,u}) of the maximum settable wheel setting angle are determined based on the vehicle speed, wherein the maximum settable nominal wheel setting angle (y_{m,n}) lies between the upper limit value (y_{m,o}) and the lower limit value (y_{m,u}).

16. The method according to claim 14, wherein, based on the deviation factor (f_{A}), a maximum wheel setting angle is determined which lies between the upper limit value (y_{m,o}) and the lower limit value (y_{m,u}) of the wheel setting angle.

17. The method according to claim 14, wherein, in understeering, and if in oversteering the measured and the calculated yaw rate have the same sign, an adjustment is made towards the lower limit value (y_{m,u}), and if in oversteering and with opposite signs, an adjustment is made towards the upper limit value (y_{m,o}).
